(19) United States
(12) Patent Application Publication
(10) Pub. No.: US 2014/0142996 A1
(43) Pub. Date: May 22, 2014

(54) SYSTEM AND METHOD FOR PASSENGERS VEHICLE MANAGEMENT

(71) Applicants: Mitchel Ian Skyer, Johns Creek, GA (US); Robert Scott Reiser, Atlanta, GA (US)

(72) Inventors: Mitchel Ian Skyer, Johns Creek, GA (US); Robert Scott Reiser, Atlanta, GA (US)

(21) Appl. No.: 14/085,570

(22) Filed: Nov. 20, 2013

Related U.S. Application Data
(60) Provisional application No. 61/729,280, filed on Nov. 21, 2012.

(51) Int. Cl. G06Q 10/02

(52) U.S. Cl. CPC G06Q 10/02
USPC 705/5

(57) ABSTRACT

An exemplary embodiment includes a method and system for providing management of a transportation system on a computer system. The management of a transportation system method is embodied in a computer program product for execution on an instruction processing system, comprising a tangible storage medium readable by the instruction processing system is storing instructions for execution by the instruction processing system. The method comprises loading passenger credential data into a database on a remote device, collecting a passenger identifying media to verify the passenger has a ticket and comparing the passenger identifying media to the passenger credential data in the database on the remote device. The method further comprises allowing the passenger to board the vehicle if the passenger has a valid ticket and following a customer operations policy action if the passenger does not have a valid ticket.

### CROSS-REFERENCE TO RELATED APPLICATION

This application is claims the benefit of U.S. Provisional patent application Ser. No. 61/729,280, filed Nov. 21, 2012, entitled “SYSTEM AND METHOD FOR PASSENGERS VEHICLE MANAGEMENT”, which is entirely incorporated herein by reference.

### TECHNICAL FIELD

The present invention relates generally to the field of transportation management, and more particularly to managing passengers and vehicles in a transportation system.

### BACKGROUND OF THE INVENTION

Public transportation services (i.e. bus, train, light rail and the like) are important public services. However, there is no effective method for managing requirements of passengers and carrying capacities of buses. For example, a bus driver has to stop at each bus stop on a specific bus route, and wait for passengers to get on the bus. If no passenger needs to get on the bus, the waiting time of the bus is wasted. Furthermore, a bus stop generally shows multiple bus routes for the passengers. The passengers have to determine one or more bus routes they need, by looking at every shown bus route one by one.

Passenger identification, counting, and maintaining a roster of passengers onboard a conveyance is an important and necessary task that is too often performed manually, with the need for the driver, operator or crew to manually keep a running count of passengers onboard. In the case of a school bus, to call roll and check passenger names off on a passenger roster.

As can be understood, conventional methods of accounting for and identifying passengers on a conveyance have many limitations. Manual methods are themselves prone to errors and do not provide an accurate real-time inventory of who is onboard and who is missing. This is a problem for commercial vessels such as trains, busses, cruise line, as well as other means of public conveyance.

It is to the provision of meeting this and other needs that the present invention is primarily directed.

### SUMMARY OF THE INVENTION

Embodiments of the present invention provide a system, method and computer program product for managing passengers and vehicles in a transportation system. An exemplary embodiment includes a system that providing management of a transportation system on a mobile device, comprising an instruction processing system and a tangible storage medium readable by the instruction processing system and storing instructions for execution by the instruction processing. The system further includes a creation module and a passenger credential data load module stored in the tangible storage medium that when executed by the instruction processing system that loads passenger credential data into a database on the remote device. The system further includes a passenger identifying media collection module stored in the tangible storage medium that when executed by the instruction processing system verifies the passenger has a ticket by comparing passenger identifying media to the passenger credential data in the database on the remote device, wherein the passenger identifying media collection module indicates allowing the passenger to board the vehicle if the passenger has a valid ticket; and wherein the passenger identifying media collection module indicates following a customer operations policy action if the passenger does not have a valid ticket.

An exemplary embodiment includes a method for providing management of a transportation system on a computer system. The management of a transportation system method is embodied in a computer program product for execution on an instruction processing system, comprising a tangible storage medium readable by the instruction processing system is storing instructions for execution by the instruction processing system. The method comprises loading passenger credential data into a database on a remote device, collecting a passenger identifying media to verify the passenger has a ticket and comparing the passenger identifying media to the passenger credential data in the database on the remote device. The method further comprises allowing the passenger to board the vehicle if the passenger has a valid ticket and following a customer operations policy action if the passenger does not have a valid ticket.

These and other aspects, features and advantages of the invention will be understood with reference to drawing figures and detailed descriptions herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view according to an example embodiment of the present FIG. 1 is a block diagram illustrating an example of the network environment for the vehicle passenger management system of the present invention.

FIG. 2A is a block diagram illustrating an example of a server utilizing the vehicle passenger management system of the present invention, as shown in FIG. 1.

FIG. 2B is a block diagram illustrating an example of a remote device utilizing the remote vehicle passenger management system of the present invention, as shown in FIG. 1.

FIG. 3 is a flow chart illustrating an example of the operation of vehicle passenger management system of the present invention utilized by the server, as shown in FIG. 2.

FIG. 4 is a flow chart illustrating an example of the operation of the vehicle configure process on the server that is utilized in vehicle passenger management system of the present invention, as shown in FIGS. 2-3.

FIG. 5 is a flow chart illustrating an example of the operation of the customer configure process on the server that is utilized in vehicle passenger management system of the present invention, as shown in FIGS. 2-3.

FIG. 6A is a flow chart illustrating an example of the operation of the ticket purchase process on the server that is utilized in vehicle passenger management system of the present invention, as shown in FIGS. 2-3.

FIG. 6B is a flow chart illustrating an example of the operation of the customer purchase transaction process on the server that is utilized by the ticket purchase process in vehicle passenger management system of the present invention, as shown in FIGS. 2-3 and 6A

FIG. 7A is a flow chart illustrating an example of the operation of the customer onboard process on the server that is utilized in vehicle passenger management system of the present invention, as shown in FIGS. 2-3.

FIG. 7B is a flow chart illustrating an example of the operation of the capture passenger data process on the server that is utilized by the customer onboard process in vehicle passenger management system of the present invention, as shown in FIGS. 2-3 and 7A.

FIG. 8 is a flow chart illustrating an example of the operation of the vehicle tracking process on the server that is utilized in vehicle passenger management system of the present invention, as shown in FIGS. 2-3.

FIG. 9 is a flow chart illustrating an example of the operation of the data display process on the server that is utilized in vehicle passenger management system of the present invention, as shown in FIGS. 2-3.

FIG. 10 is a flow chart illustrating an example of the operation of the status reports process on the server that is utilized in vehicle passenger management system of the present invention, as shown in FIGS. 2-3.

The detailed description explains the preferred embodiments of the invention, together with advantages and features, by way of example with reference to the drawings.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

This present invention is directed to an electronic passenger counting and reporting system and its corresponding techniques that can be applied to buses, shuttles, taxis, limos and similar vehicles. The system mainly consists of the following parts: a driver-managed passenger counting and vehicle management touch screen and CPU, optional external input/counting devices (magnetic card swipe, RFID, touch screen, biometric, or other passenger validating capture device), WIFI, cellular or other radio frequency connection to the Internet, Customer and vehicle configuration management server, Passenger count upload database, and Reporting server. The onboard equipment is designed to be installed quickly, in an already operating vehicle, self-contained with no Internet connection necessary except periodically to upload and download data. The system can be used to count passengers both boarding and alighting, as well as count various passenger types, recording vehicle, driver, route, stop, latitude, longitude, time & date, through the driver-managed touch screen. It can also count passengers through external input/capture devices, as well as validate the ability of the rider to ride. The system is used to count, validate as necessary, compile, automatically upload and report on the ridership, immensely improving the accuracy of rider counts as well as automating and simplifying the compilation of counts at the vehicle and system level. This will then allow the operators to review the counted passengers and adjust routes, schedules, stops, and vehicles as necessary.

The invention described hereafter is applicable on all remote devices connected to a server hosting the vehicle passenger management system and method of the present invention. While described below with respect to a single computer, the system and method for a webpage system is typically implemented in a networked computing environment in which a number of computing devices communicate over a local area network (LAN), over a wide area network (WAN), or over a combination of both LAN and WAN.

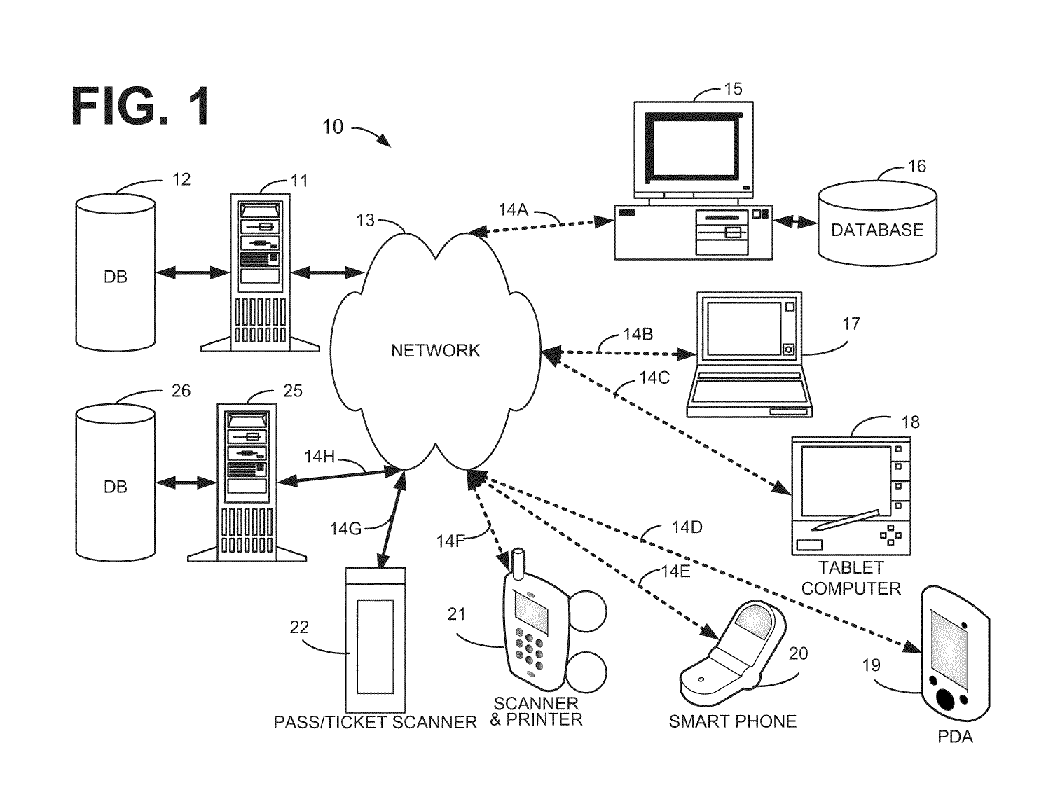

Referring now to the drawings, in which like numerals illustrate like elements throughout the several views. FIG. 1 illustrates an example of the basic components of a system 10 using the vehicle passenger management system in connection with the preferred embodiment of the present invention. The system 10 includes a server 11 and the remote devices 15 and 17-22 that utilize vehicle passenger management system of the present invention. The system 10 also includes a mobile scanner/printer 21 and a stand-alone scanner 22 for scanning passes. In the preferred embodiment, the passes are printed on paper. However, in alternative embodiments, the passes may be digitally stored on the remote device 17-20 that are then scanned by the mobile scanner/printer 21 and a stand-alone scanner 22 when the user customer arrives at the parking lot destination. Passes can be made up with any of a number of types of identifying IDs including, but are not limited to, barcode's, student IDs, drivers license, apps on a smart phone, credit cards, dongles and the like.

Each of the remote devices 15, 17-22 has applications and can have a local database 16. Server 11 contains applications, and a database 12 that can be accessed by remote devices 15 and 17-22 via connections 14 (A-G), respectively, over network 13. The server 11 runs administrative software for a computer network and controls access to itself and database 12. The remote devices 15 and 17-22 may access the database 12 over a network 13, such as but not limited to: the Internet, a local area network (LAN), a wide area network (WAN), via a telephone line using a modem (POTS), Bluetooth, Wi-Fi, cellular, optical, satellite, RF, Ethernet, magnetic induction, coax, RS-485, the like or other like networks. The server 11 may also be connected to the local area network (LAN) within an organization (i.e. a university, military base, sports stadiums, medical complex or the like).

The remote devices 15 and 17-22 may each be located at remote sites. Remote devices 15 and 17-22 include but are not limited to, PCs, workstations, laptops, handheld computers, smart phones, pocket PCs, PDAs, pagers, WAP devices, non-WAP devices, cell phones, palm devices, printing devices, mobile scanner/printer and a stand-alone scanner and the like. Included with each of the remote devices 15 and 17-22 is an ability to process a ticket transaction on network 13. On the remote devices 15 and 17-20 there is a printer for printing out a travel pass. In remote devices 15 and 17-22, there is the ability for displaying and/or scanning the travel pass on a display screen.

Thus, when a user at one of the remote devices 15 and 17-20 desires to access travel pass status from the database 12 at the server 11, the remote devices 15 and 17-22 communicate over the network 13, to access the server 11 and database 12. The mobile scanner/printer 21 and a stand-alone scanner 22 provide for an attendant or automated scanning of the travel pass using a detachable or fixed scanning module. The mobile scanner/printer 21 and a stand-alone scanner 22 may also provide for the remote purchase of travel pass and printing of the same.

Third party vendors computer systems 25 and databases 26 can be accessed by vehicle passenger management system 100 on server 11 in order to process will travel pass transactions for event providers wanting to provide integrated, event ticket purchasing along with prepaid travel pass reservations. Data that is obtained from third party vendors computer systems 25 and databases 26 can be stored on server 11 and database 12 in order to provide later access to the user on remote devices 15 and 17-22. It is also contemplated that for certain types of data that the remote devices 15 and 17-22 can access the third party vendors computer systems 25 and databases 26 directly using the network 13.

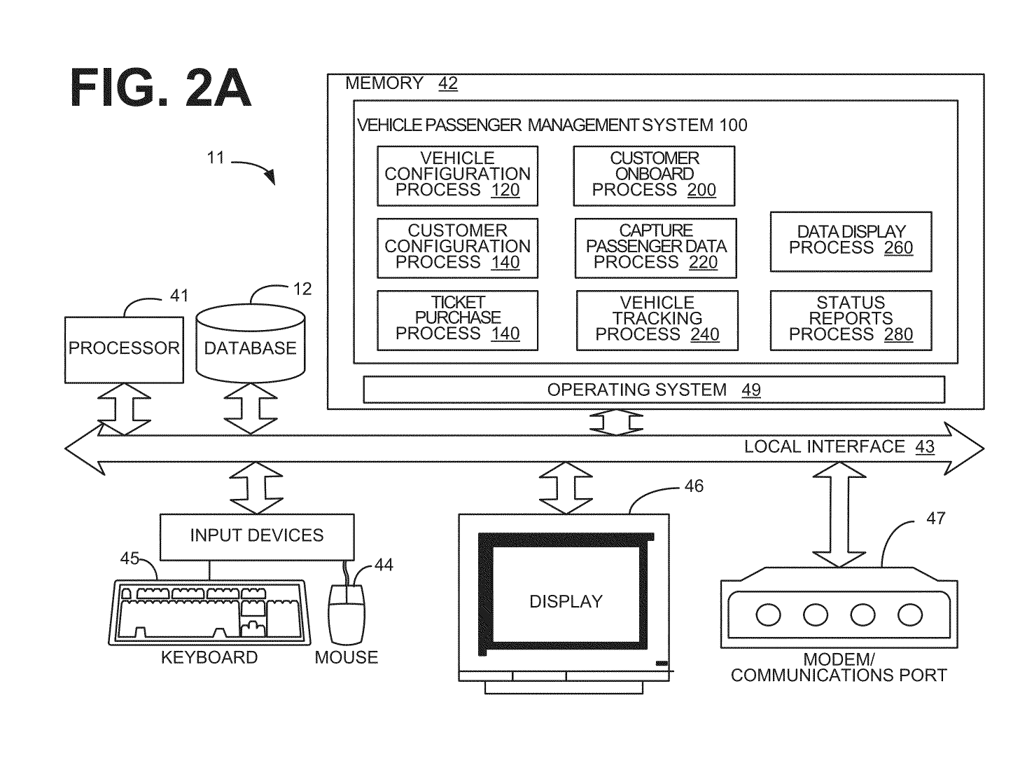

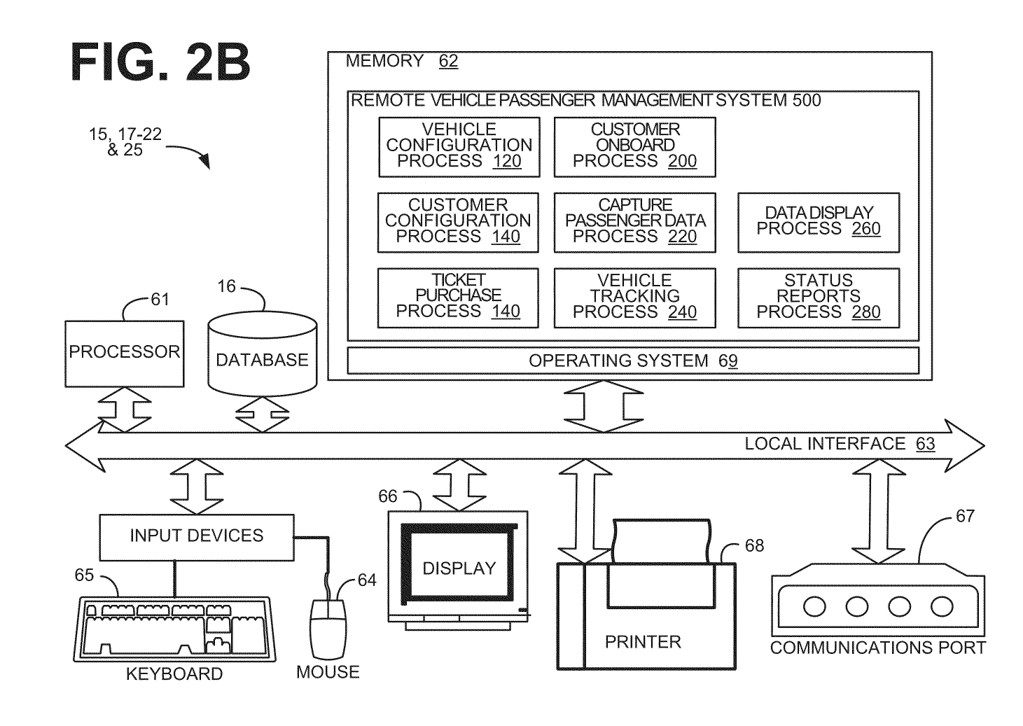

Illustrated in FIG. 2A is a block diagram demonstrating an example of server 11, as shown in FIG. 1, utilizing vehicle passenger management system 100 of the present invention. Server 11 includes, but is not limited to, PCs, workstations, laptops, PDAs, palm devices, smart phones and the like.

Generally, in terms of hardware architecture, as shown in FIG. 2, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and vehicle passenger management system 100 of the present invention. As illustrated, vehicle passenger management system 100 of the present invention comprises numerous functional components including, but not limited to, the vehicle configure process 120, customer configure process 140, ticket purchase process 160, customer purchase transaction process 180, the customer onboard process 200, capture passenger data process 220, vehicle tracking process 240, data display process 260, and status reports process 280.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as vehicle passenger management system 100, and provides scheduling, input-output control, file and data management, memory management, and communication control and related services. However, it is contemplated by the inventors that vehicle passenger management system 100 of the present invention is applicable on all other commercially available operating systems.

Vehicle passenger management system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, vehicle passenger management system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, assembler, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. Vehicle passenger management system 100 and the O/S 49 are read, in whole or in part, by the processor 41, perhaps buffered within the processor 41, and then executed.

When vehicle passenger management system 100 is implemented in software, as is shown in FIG. 2A, it should be noted that vehicle passenger management system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where vehicle passenger management system 100 is implemented in hardware, vehicle passenger management system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 2B is a block diagram illustrating an example of a remote device utilizing the remote vehicle passenger management system 500 for the remote devices 15 and 17-20, as shown in FIG. 1. The remote devices 15 and 17-20 provide access to the vehicle passenger management system 100 of the present invention on server 11 and database 12 using for example, but not limited to an Internet browser. The information accessed in server 11 and database 12 can be provided in the number of different forms including, but not limited to, ASCII data, WEB page data (i.e. HTML), XML or other type of formatted data. As illustrated, the remote devices 15 and 17-20 include many of the same components as server 11 described with regard to FIG. 2A. These components include processor 61, memory 62, local interface 63, mouse 64, keyboard/keypad 65, display 66, communication port 67 and operating system 69. One addition is printer 68. Hereinafter, the remote devices 15 and 17-20 are devices that will be referred to as remote devices 15 for the sake of brevity.

The remote vehicle passenger management system 500 is located in memory 62 of the remote devices 15. As illustrated remote vehicle passenger management system 500 of the present invention comprises numerous functional components including, but not limited to, the vehicle configure process 120, customer configure process 140, ticket purchase process 160, customer purchase transaction process 180, the customer onboard process 200, capture passenger data process 220, vehicle tracking process 240, data display process 260, and status reports process 280.

When the remote vehicle passenger management system 500 is implemented in software, as is shown in FIG. 2B, it can be stored on virtually any computer readable medium for use by or in connection with any computer related system or method. In an alternative embodiment, where the remote vehicle passenger management system 500 is implemented in hardware, the remote vehicle passenger management system 500 can be implemented in the same way as described above with regard to the remote vehicle passenger management system 500 (FIG. 2).

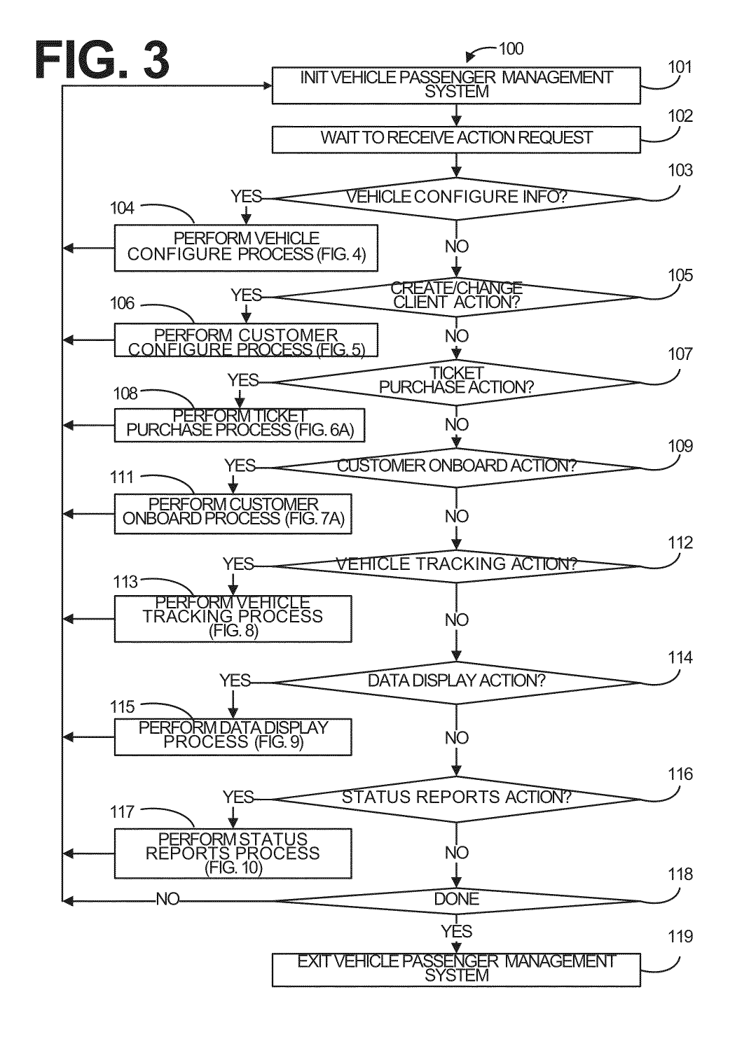

FIG. 3 is a flow chart illustrating an example of the operation of vehicle passenger management system 100 of the present invention utilized by the server 11, as shown in FIG. 2. Vehicle passenger management system 100 of the present invention provides a customer with the ability to purchase a vehicle pass or ticket that is noted in a database 12 in a server 11 which communicates with the remote vehicle passenger management system in real time. In the prior art, they must take that information from their server and individually upload the info into each remote device 15. The vehicle passenger management system and method of the present invention also offers the customer (i.e. person/entity contracting to manage the vehicles and tickets) to log into in a database 12 in a server 11 (i.e. a website) and review in real time what is happening with the vehicle activity.

First at step 101, vehicle passenger management system 100 is initialized. This initialization includes the startup routines and processes embedded in the BIOS of the server 11. The initialization also includes the establishment of data values for particular data structures utilized in vehicle passenger management system 100.

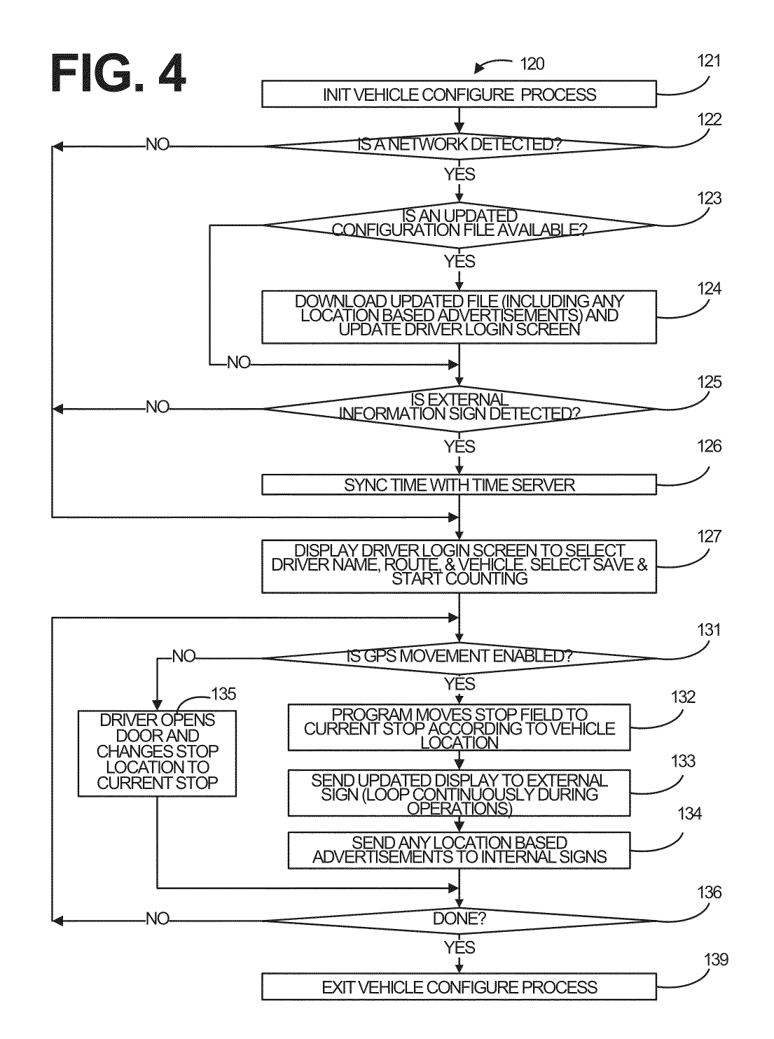

At step 102, vehicle passenger management system 100 waits to receive an action request. Once an action is received at step 102, it is determined if the action is to input vehicle configuration information to the vehicle passenger management system 100 at step 103. If it is determined that the action is not to input vehicle configuration information to the vehicle passenger management system 100, then vehicle passenger management system 100 skips to step 105. However, if it is determined in step 103 that vehicle configuration information is to be added, then vehicle passenger management system 100 performs the vehicle configure process at step 104. The vehicle configure process that is herein defined in further detail with regard to FIG. 4. After performing the vehicle configure process, the vehicle passenger management system 100 returns to step 102.

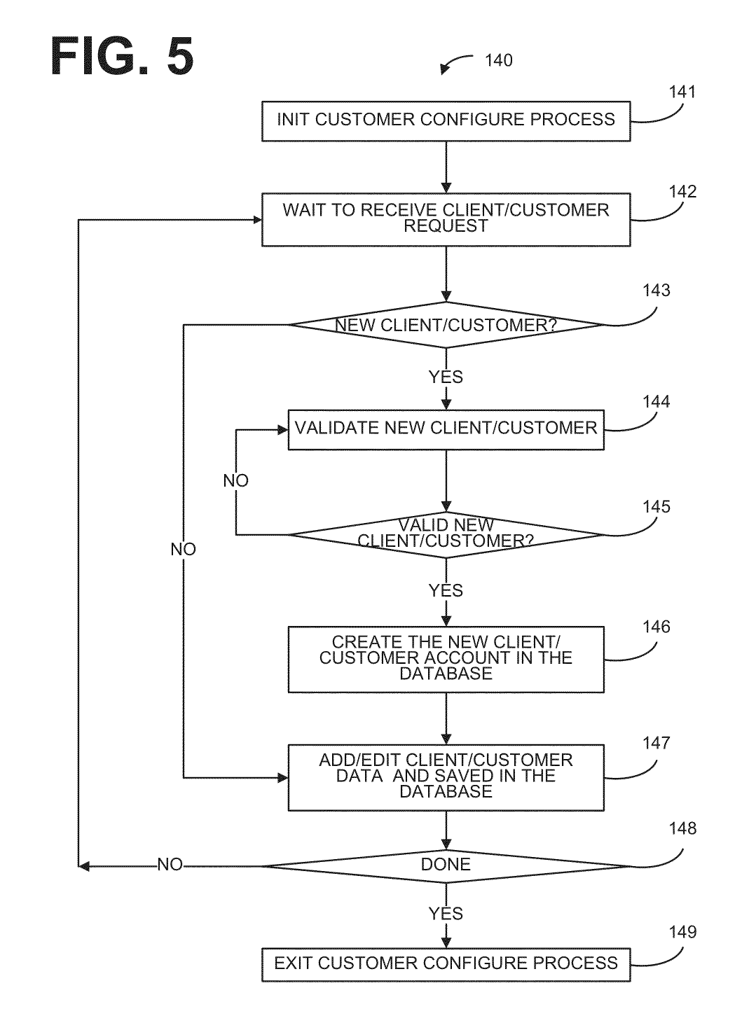

At step 105, it is determined if the action is to create or change a client information action. If it is determined that the action is not a create or change a client information action, then vehicle passenger management system 100 skips to step 107. However, if it is determined in step 105 that the action is a create or change a client information action, then vehicle passenger management system 100 performs the customer configure process at step 106. The customer configure process is herein defined in further detail with regard to FIG. 5. After performing the customer configure process, the vehicle passenger management system 100 returns to step 102.

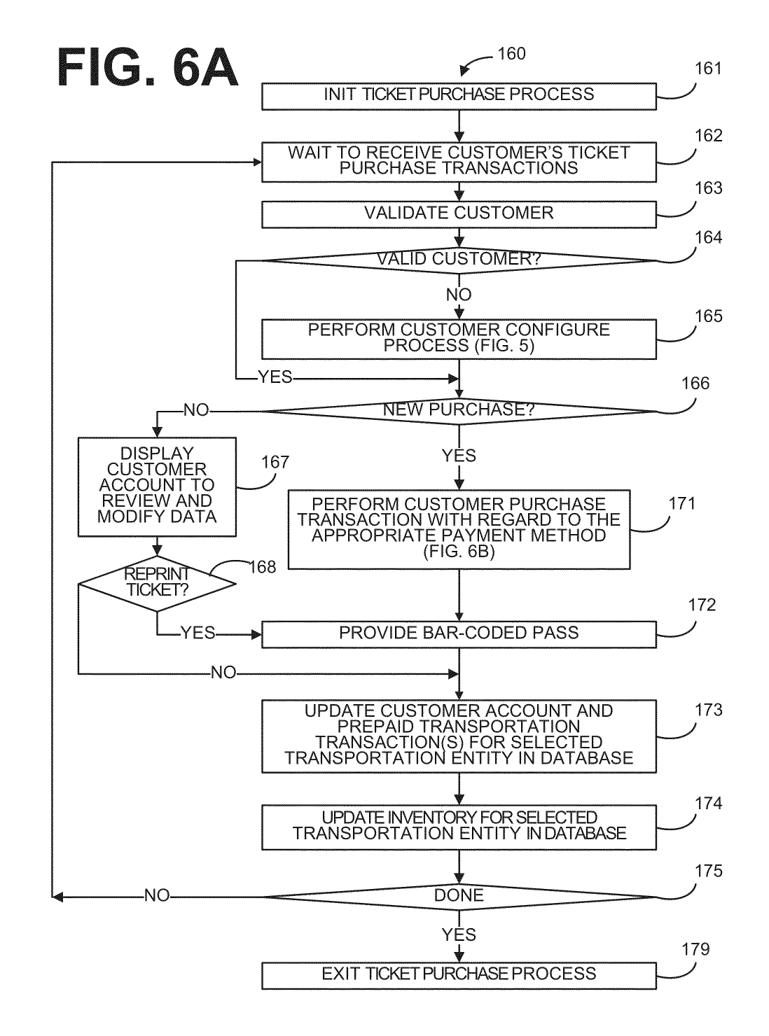

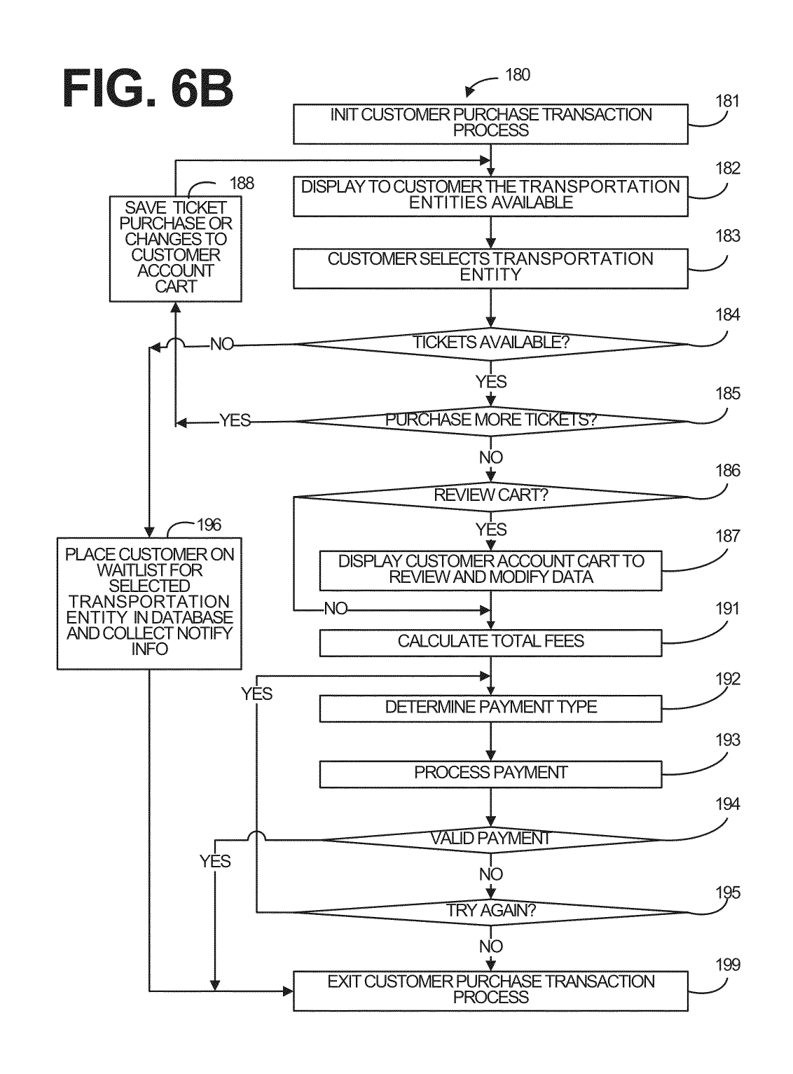

At step 107, it is determined if the action is a ticket purchase action. In one embodiment, the ticket purchase action is to purchase a travel pass for a single day. In another embodiment, a ticket purchase action is a scenario in which the customer wishes to purchase a travel pass for more than one day. Examples include, but are not limited to a today travel pass, a workweek travel pass, a seven day travel pass, a 14 day travel pass, a monthly travel pass and the like. If it is determined that the action is not a ticket purchase action, then vehicle passenger management system 100 skips to step 109. However, if it is determined in step 107 that the action is a ticket purchase action, then vehicle passenger management system 100 performs the ticket purchase process at step 108. The ticket purchase process is herein defined in further detail with regard to FIG. 6A. After performing the ticket purchase process, the vehicle passenger management system 100 returns to step 102.

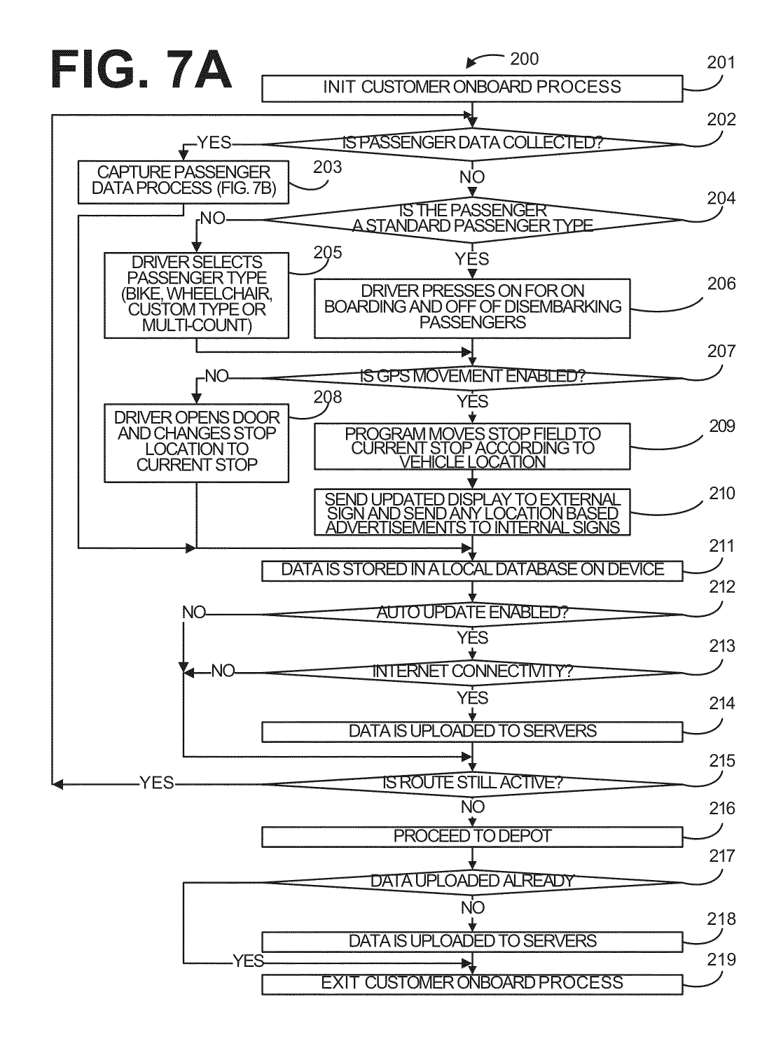

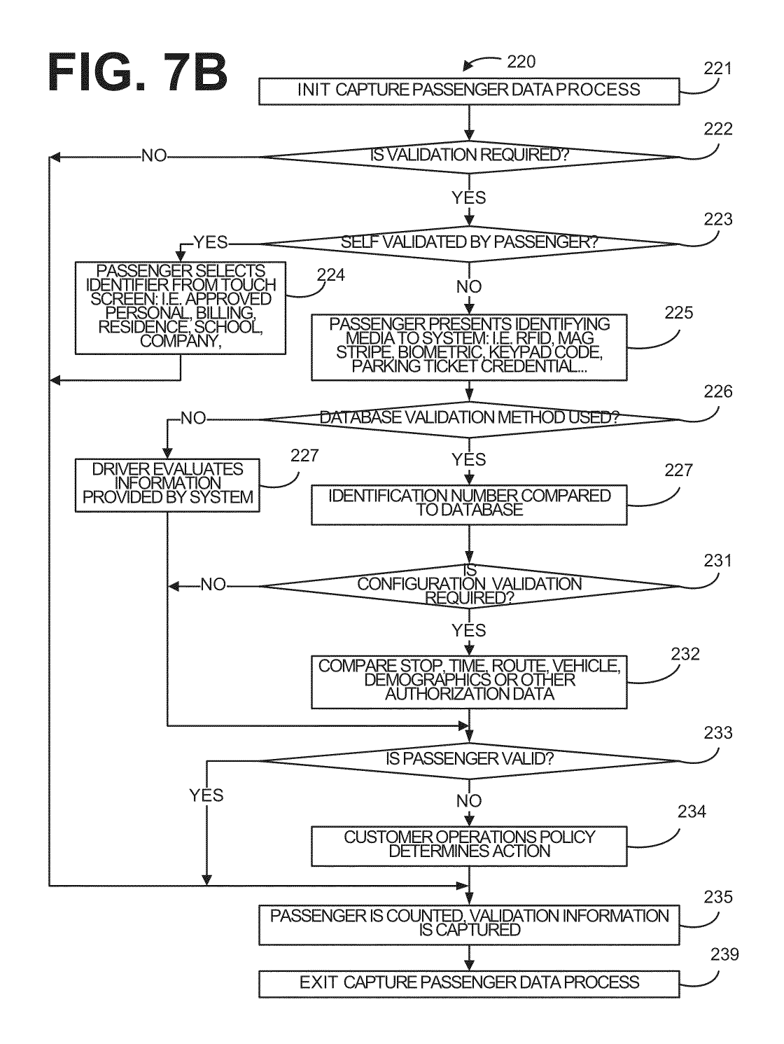

At step 109, it is determined if the action is a customer onboard action. If it is determined that the action is not a customer onboard action, then vehicle passenger management system 100 skips to step 112. However, if it is determined in step 109 that it is a customer onboard action, then vehicle passenger management system 100 performs the customer onboard process at step 111. The customer onboard process is herein defined in further detail with regard to FIG. 7A. After performing the customer onboard process, the vehicle passenger management system 100 returns to step 102.

At step 112, it is determined if the action is a vehicle tracking action. If it is determined that the action is not a vehicle tracking action, then vehicle passenger management system 100 skips to step 114. However, if it is determined in step 112 that it is a vehicle tracking action, then vehicle passenger management system 100 performs the vehicle tracking process at step 113. The vehicle tracking process is herein defined in further detail with regard to FIG. 6. After performing the long term process, the vehicle passenger management system 100 returns to step 102.

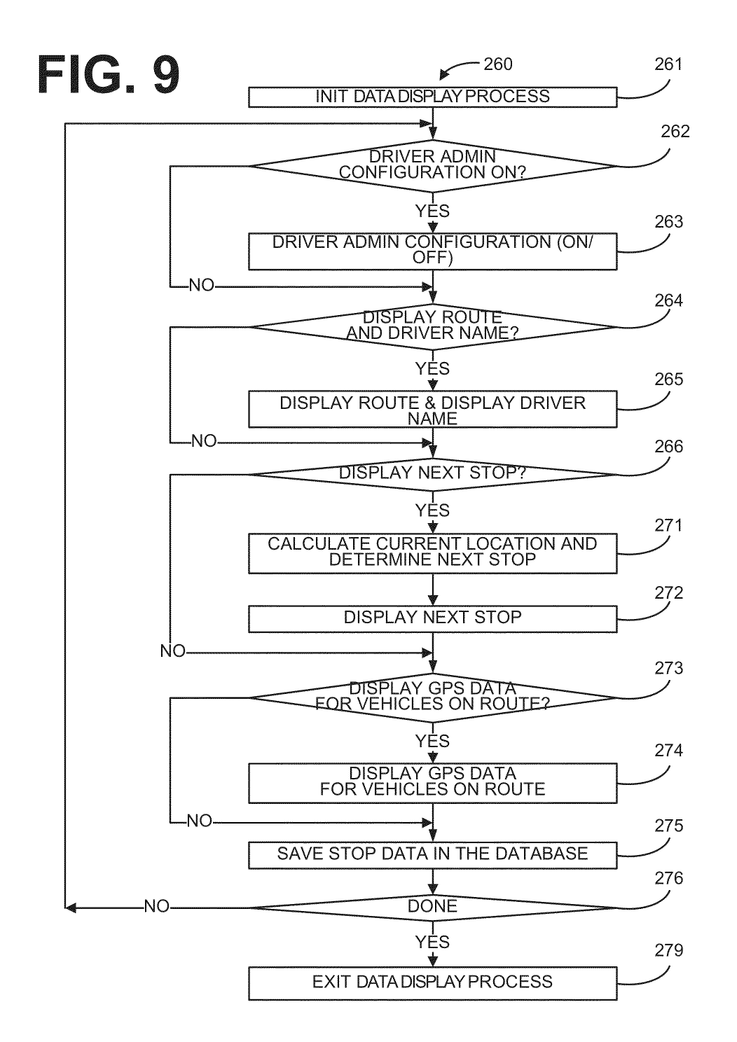

At step 114, it is determined if the action is a data display action. If it is determined that the action is not a data display action, then vehicle passenger management system 100 skips to step 116. However, if it is determined in step 114 that the action is a data display action, then vehicle passenger management system 100 performs the data display process at step 115. The data display process is herein defined in further detail with regard to FIG. 9. After performing the data display process, the vehicle passenger management system 100 returns to step 102.

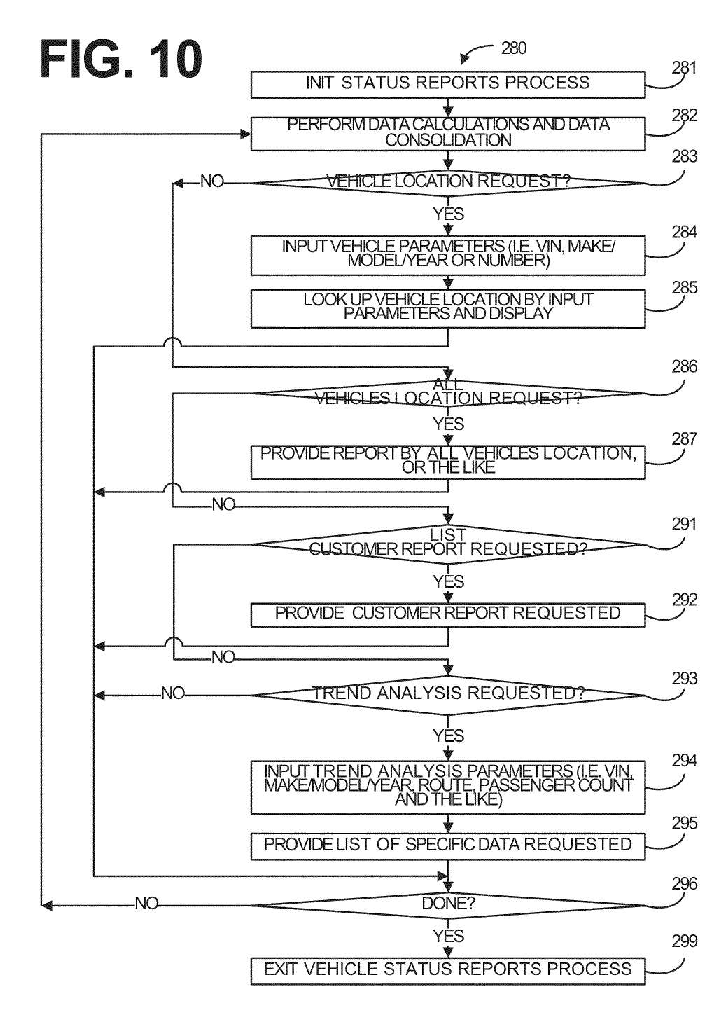

At step 116, it is determined if the action is a status report action. In one embodiment, a status report action enables management to receive reports with regard to a vehicle's location, all vehicles location, violators, status of the vehicle's routes, list of customer report, trend analysis and the like. If it is determined that the action is not a status report action, then vehicle passenger management system 100 skips to step 118. However, if it is determined in step 116 that the action is a status report action, then vehicle passenger management system 100 performs the status report process at step 117. The status report process is herein defined in further detail with regard to FIG. 10. After performing the status report process, the vehicle passenger management system 100 returns to step 102.

At step 118, it is determined if vehicle passenger management system 100 is to wait for additional action request. If it is determined at step 118 that vehicle passenger management system is to wait to receive additional actions, then vehicle passenger management system 100 returns to repeat steps 102 through 118. However, if it is determined at step 115 that there are no more actions to be received, then vehicle passenger management system 100 then exits at step 119.

FIG. 4 is a flow chart illustrating an example of the operation of the vehicle configure process 120 on the server that is utilized in vehicle passenger management system 100 of the present invention, as shown in FIGS. 2-3. The vehicle configure process 120 can establish or modify vehicle specific information residing on database 12 (FIG. 2). Once the vehicle information is placed in server 11, it is available for downloading to and updating each vehicle. A brief overview of one exemplary process is as follows: 1) determines if a network is detected and skips to display driver login screen if network is not detected; 2) if the network is detected, then it is determined if an updated configuration file is available; 3) if an updated file is available, then it is downloaded to the vehicle and updates the driver login screen, and if not available, skips to the next step; 4) determine if external information sign is detected on the vehicle; 5) if an external information sign is detected then it is synced with the time server and if no external information sign is detected, then skip to the next step; 6) display driver login screen to select driver name, route and vehicle and save to database 12; 7) determine if GPS movement is enabled on the vehicle; 8) if GPS movement is not enabled, then each and every time the driver opens the door the stop location captured is changed to the current stop; 9) if GPS movement is enabled, then the program moves the stop field to the current stop according to the vehicle's location and send the updated display to the external sign so that is continuously looping during operation; 10) determining if movement is still to be tracked for the vehicle and returning to repeat steps 7-9 if vehicle movement is still to be tracked and 11) exiting if vehicle movement ceases to be tracked.

First at step 121, the vehicle configure process 120 is initialized. This initialization includes the startup routines and processes embedded in the BIOS of the server 11. The initialization also includes the establishment of data values for particular data structures utilized in the vehicle configure process 120.

At step 122, the vehicle configure process 120 determines if a network is detected. If no network is detected, then the vehicle configure process 120 skips step 127. However, if a network is detected, it is then determined if an updated configuration file is available, at step 123. If an updated configuration file not available, then the vehicle configure process 120 skips to step 125. However, if it is determined that an updated file is available, then it is downloaded to the vehicle and updates the driver login screen, at step 124. Also at step 124 any location based advertisements on the vehicle route are downloaded to a local database on the device. These location-based advertisements can be displayed to passengers of the vehicle. The advertisements will be displayed for the next stop as soon as the vehicle proceeds from a prior stop. At step 125, it is determined if an external information sign is detected on the vehicle. If no external information sign is detected, then the vehicle configure process 120 skips to step 127. However, if an external information sign is detected, it is synced with the time server 25, at step 126. The time server 25 is any type of trust time clock in order to calibrate the GPS clock on the vehicle. In the preferred embodiment, the time clock 25 is an atomic time clock (not shown). It is connected to using TCP/IP protocol. In an alternative embodiment, the trusted time clock is a GSM, CDMA, GPS or the like clock. In this in alternative embodiment, the time clock is connected to the vehicle utilizing a satellite or cellular signal.

At step 127, the vehicle configure process 120 displays the driver login screen. The driver login screen allows the driver to select who is driving the vehicle, the route that the vehicle is to follow and save this information to a local database 16 that is then uploaded to database 12 at a later time.

At step 131, it is determined if GPS movement is enabled on the vehicle. If it is determined that GPS movement is not enabled, then the vehicle configure process 120 skips step 135. However, if GPS movement is enabled, then the vehicle configure process 120 moves the current stop field to the current stop according to the vehicle's current location, at step 132. At step 133, the vehicle configure process 120 sends the updated display to the external sign so that is continuously looping during operation. At step 134, any location based advertisements for the next stop are displayed on internal signs. In the preferred embodiment, the location-based advertisements are displayed for the next stop upon arriving at the current stop. However, in an alternative embodiment, any location based advertisements to be displayed can be displayed on an internal sign a predetermined number of stops prior to arriving at the location for the location-based advertisement. The vehicle configure process 120 skips step 136.

At step 135, each and every time the driver opens the door the stop location captured is changed to the current stop.

At step 136, it is determined if movement is still to be tracked for the vehicle. It is it is determined that the vehicle location is to be tracked, then the vehicle configure process 120 returns to repeat steps 131-135. However, if it is determined at step 135 that the vehicle location ceases to be tracked, then the vehicle configure process 120 exits at step 139.

FIG. 5 is a flow chart illustrating an example of the operation of the customer configure process 140 on the server that is utilized in vehicle passenger management system 100 of the present invention, as shown in FIGS. 2A-3. The customer configure process 140 can establish or modify customer specific information residing on database 12 (FIG. 2A).Once the new customer information is placed in server 11, it is available for customer parking reservations. A brief overview of one exemplary process is as follows: 1) waits to receive a customer configure request; 2) determine if the customer is a new customer; 3) Validate and store new customer name; 4) upload new/modify existing customer information from local machine; and 5) done.

First at step 141, the customer configure process 140 is initialized. This initialization includes the startup routines and processes embedded in the BIOS of the server 11. The initialization also includes the establishment of data values for particular data structures utilized in the customer configure process 140.

At step 142, the customer configure process 140 waits to receive a new customer request. Once a new customer request has been received, the customer configure process 140 determines if the customer is a new customer to vehicle passenger management system 100. If it is determined at step 143 that the customer is not a new customer, then the customer configure process 140 skip step 147 to enable the customer to enter new or edit existing customer data. However, if it is determined at step 143 that the customer is a new customer, then the customer configure process 140 validates the new customer at step 144. The new customer is registered at this time and is validated against information in database 12 at step 145. This information may include validating the customer payment method. If the new customer is not valid, then the customer configure process 140 returns to step 144. However, if the new customer is valid, then the customer configure process 140 enables the new customer to create a new customer account at step 146.

At step 147, the customer configure process 140 enables the customer to add or edit existing customer data in the new customer account.

At step 148, it is determined if the customer configure process 140 is to wait for additional customer requests. If it is determined at step 148 that the customer configure process 140 is to wait for additional customer requests, then the customer configure process 140 returns to repeat steps 142 through 148. However, if it is determined at step 148 that there are no more customer actions to be received, then the customer configure process 140 then exits at step 149.

FIG. 6A is a flow chart illustrating an example of the operation of the ticket purchase process 160 on the server that is utilized in vehicle passenger management system 100 of the present invention, as shown in FIGS. 2A-3. Once the new customer is placed in server 11, it is available for reservation transaction to occur. A brief overview of one exemplary process is as follows: 1) waits for a customer to purchase a ticket; 2) determine if a customer account established and establishing the customer if not; 3) determines if the ticket purchase is a new ticket purchase or a renewal; 4) if a renewal, displaying the customer account information and determining if a reprinted ticket is required, and if so providing such; 5) if a new ticket purchase, performing the customer purchase transaction with the appropriate payment method herein defined in further detail with regard to FIG. 6B; 6) provide bar-coded pass; 7) update customer account with ticket transaction information; 8) update inventory in the selected transportation into the in database and 9) determine if more tickets are to be purchased and if so returning to repeat step 162-175, or exit.

First at step 161, the ticket purchase process 160 is initialized. This initialization includes the startup routines and processes embedded in the BIOS of the server 11. The initialization also includes the establishment of data values for particular data structures utilized in the ticket purchase process 160.

At step 162, the ticket purchase process 160 waits to receive a customer reservation transaction. Once a customer reservation transaction has been received, the ticket purchase process 160 then validates that the customer account exists at step 163. At step 164, the ticket purchase process 160 determines if the customer is a current customer. If the customer account exists, then the ticket purchase process 160 skip step 166. However, if a customer account does not exist for the new customer, the customer configure process 120 is performed at step 165.

At step 166, it is determined if the ticket purchase transaction is a new purchase. If it is determined that the ticket purchase transaction is a new purchase, then the ticket purchase process 160 skip to step 171. However, it is determined that the ticket purchase transaction is not a new purchase, then the ticket purchase process 160 displays the customer account information for review and modification of the data at step 167. At step 168, it is determined if the parking pass is to be reprinted. If it is determined at step 168 that the parking pass is to be reprinted, then the ticket purchase process 160 proceeds to step 172. However, if it is determined at step 168 that the ticket purchase transaction is to reprint the pass, then the ticket purchase process 160 proceeds to step 173.

At step 171, the customer ticket purchase transactions is processed with regard to the appropriate payment method. The customer purchase transactions is herein defined in further detail with regard to FIG. 6B. After performing the customer purchase transactions, the ticket purchase process 160 provides the customer with a travel pass at step 172. In a preferred embodiment, this bar code pass it is printed. However, in alternative embodiments, this travel pass can be an image that is sent to the remote devices 20 for further presentation upon arriving to board the vehicle. At step 173, the ticket purchase process 160 updates the customer account and the transportation transaction for the selected transportation entity in database 12. At step 174, the inventory is updated for the selected transportation entity in database 12.

At step 175, it is determined if the ticket purchase process 160 is to wait for additional customer transactions. If it is determined at step 175 that the ticket purchase process 160 is to wait for additional customer transactions, then the ticket purchase process 160 returns to repeat steps 162 through 175. However, if it is determined at step 175 that there are no more customer transactions to be received, then the ticket purchase process 160 then exits at step 179.

FIG. 6B is a flow chart illustrating an example of the operation of the customer purchase transaction process 180 on the server 11 that is utilized in customer purchase transaction process 180, as shown in FIGS. 3 and 5A. Once a customer purchase transaction process 180 commences, it is the customer purchase transaction process 180 that processes the transportation transaction. A brief overview of one exemplary process is as follows: 1) displays to the customer the transportation entities available; 2) let customer select transportation entity desired; 3) determining if a ticket is available for the transportation entities selected by the customer; 4) placing customer on a wait list if a ticket is not available from the transportation entity selected; 5) if a ticket with the transportation entity desired is available then determine if the customer wishes to purchase additional tickets(s); 6) saving the slot purchase or changes to a customer account cart if the customer wishes to purchase additional tickets(s) and returned to step 1; 7) display customer account cart if the customer wants to review their cart; 8) calculating the total fees for the ticket(s) to be purchased; 9) determine payment type and process payment; 12) determining if the payment was valid and trying again if invalid; and 13) exit.

First at step 181, the customer purchase transaction process 180 is initialized. This initialization includes the startup routines and processes embedded in the BIOS of the server 11. The initialization also includes the establishment of data values for particular data structures utilized in the customer purchase transaction process 180.

At step 182, the customer purchase transaction process 180 displays to the customer the transportation entities available. In one embodiment, this can be only the transportation entity managed by the operator of the vehicle passenger management system 100. In an alternative embodiment, the transportation entities displayed can be all available transportation providers. At step 183, the customer purchase transaction process 180 lets customer select transportation entity desired. The transportation entity is selected from those displayed to the customer at step 182.

At step 184, it is determined if a ticket is available for the transportation entities selected by the customer. If it is determined at step 184 that there is not a ticket available from the desired transportation entity, then the customer purchase transaction process 180 then skips to step 196. However, if it is determined at step 184 that the ticket is available, then it is determined if the customer wishes to purchase more than one ticket at step 185. If it is determined at step 185 that the user does want to purchase additional tickets(s), then the customer purchase transaction process 180 then skips to step 188 and saves the ticket purchase or changes to a customer account cart, and then will to step 182. However, if it is determined at step 185 that the customer does not wish to purchase more tickets, then the customer purchase transaction process 180 determines if the customer wishes to review his customer account cart at step 186. If it is determined at step 186 that the customer does not wish to review his customer account cart, then the customer purchase transaction process 180 then skips to step 191. However, if it is determined at step 186 that the user does wish to review his customer account cart, then the customer purchase transaction process 180 displays the customer account cart information for review and modification at step 187. Any modifications made to the data are updated instantaneously to database 12.

At step 191, the total fees are calculated for the ticket(s). The total fees include, but are not limited to, the cost of the ticket (as), any handling fees, any pass reprint fees and any outstanding violations i.e. citations incurring a fine.

At step 192, the customer purchase transaction process 180 determines the payment type and then processes the payment at step 193. At step 194, it is determined if the payment transaction was valid. If it is determined at step 194 that the payment transaction was valid, then the customer purchase transaction process then skips to step 199. However, if it is determined at step 194 that the payment was not a valid payment, then it is determined at step 195 if the payment is to be retried. If it is determined at step 195 that the payment is to be retried, then the customer purchase transaction process 180 then returns to repeat steps 192-195. However, if it is determined at step 195 that the payment transaction is not to be retried, then the customer purchase transaction process skips to step 199.

At step 194, it is determined if the payment was valid. If the payment is valid, then the customer purchase transaction process 180 skips to step 199. However, if the payment was not valid, then it is determined if the customer purchase transaction process 180 is to try again at step 195. If it is determined that the payment is not to be attempted again, then the customer purchase transaction process then exits at step 199. However, if it is determined in step 195 that the payment is to be reattempted, then the customer purchase transaction process 180 returns to repeat steps 192-195.

At step 196, the customer purchase transaction process 180 places the customer on a wait list for the selected transportation entity if a ticket is not available from the transportation entity selected. Contact information is collected from the customer and stored in database 12. In the future time should a ticket become available from the desired transportation entity, then the vehicle passenger management system 100 of the present invention will initiate a contact with the customer to investigate whether or not customer is still interested in buying a ticket.

At step 199, the customer purchase transaction process 180 exits and returns control to step 171 in FIG. 6A.

FIG. 7A is a flow chart illustrating an example of the operation of the customer onboard process 200 on the server 11 is utilized in vehicle passenger management system 100 of the present invention, as shown in FIGS. 2A-3. The customer onboard process 200 is used to capture passenger data, track vehicle movement and save it to remote device 21/22 and servers 11. A brief overview of one exemplary process is as follows: 1) determine if the passenger data is to be collected; 2) if passenger data is to be collected then execute the capture passenger data process; 3) if passenger data is not to be collected, then determine if the passenger getting onboard is of a standard passenger type; 4) if the passenger is not a standard passenger type the driver selects the passenger type and saves that to the remote device 21/22; 5) if the passenger is a standard passenger type, then the driver presses on four onboarding and offloading passengers; 6) determining if GPS movement is enabled on the vehicle.; 7) if movement is not enabled, then the driver of the vehicle must initiate the change of stop location to the current stop manually; 8) if GPS movement is enabled, then the customer onboard process 200 automatically up dates the current stop information according to the vehicle location and sends this data to the external sign; 9) after the current location and stop information is determined, it is saved to the local database 16 on the remote device; 10) it is determined if the auto update is enabled and Internet connectivity is available; 11) if both of these are true, then the data is uploaded to server 11 database 12; 12) it is then determined if the route is still active and if so, return to repeat steps 1-12; 13) if it is determined that the route is not still active, then the vehicle proceeds to the vehicle depot: 14) once at the vehicle depot, it is determined if all the local store data has been uploaded to server 11 and if not the data is then uploaded to servers; and 15) exit the customer onboard process.

First at step 201, the customer onboard process 200 is initialized. This initialization includes the startup routines and processes embedded in the BIOS of the server 11. The initialization also includes the establishment of data values for particular data structures utilized in the customer onboard process 200.

At step 202, the customer onboard process 200 determines if the passenger data is to be collected. If it is determined that the passenger data is to be collected, then the customer onboard process 200 performs the capture passenger data process at step 203. The capture passenger data process is herein defined in further detail with regard to FIG. 7B. After initiating the capture passenger data process at step 203, the customer onboard process 200 then skips to step 211. If it is determined at step 202 that the passenger data is not to be collected, then the customer onboard process 200 determines if the passenger getting onboard is of a standard passenger type at step 204. If it is determined that the passenger is not a standard passenger type, then the driver is requested to manually indicate the passenger type and saves that to the remote device 21/22. The nonstandard passenger types include, but are not limited to, those passengers with a bike, in a wheelchair, of a custom type or a multi-count. A custom type is a user-defined passenger classification. Examples include, but are not limited to demographic data and operational data. Demographic data includes, but is not limited to, location, school, most frequent areas for pickup, most frequent areas for drop-off and the like. Operational data includes, but is not limited to, passengers left behind, status of the vehicle, passenger billing codes and the like. A multi-count is when the driver of the vehicle selects the number of passengers boarding or disembarking the bus in a group of two or more. The customer onboard process 200 then skips to step 207.

However, if it is determined at step 204 that the passenger is a standard passenger type, the driver documents this on remote device 21/22. In one embodiment, this is captured by manually pressing on for boarding passengers and off for disembarking passengers at step 206. In an alternative embodiment, this is accomplished automatically through the use of light sensors and the like. In the automated environment, each time a passenger boards a vehicle, the count of current people on the vehicle goes up by the number of people boarding the vehicle. The converse is true for the automated embodiment, wherein each time a passenger exits the vehicle, the count of current people on the vehicle is decreased by the number of people exiting the vehicle. Still another alternative embodiment, wherein the vehicle has two doors for passenger entrance and exit, the driver documents counts the number of embarking and disembarking passengers, and there is automated counting at the back door.

At step 207, it is determined if GPS movement is enabled on the vehicle. If movement is not enabled, then the driver of the vehicle must manually initiate the change of stop location to the current stop at step 208. The customer onboard process 200 then skips to step 211. However, if GPS movement is enabled, then the customer onboard process 200 automatically updates the current stop information according to the vehicle location at step 209 and sends this data to the external sign at step 210. Since GPS movement is enabled, then the customer onboard process 200 continuously sends the vehicle stop location to be displayed on the external sign during vehicle operations. Also at step 210, any location based advertisements for the next stop are displayed on internal signs. In the preferred embodiment, the location-based advertisements are displayed for the next stop upon arriving at the current stop. However, in an alternative embodiment, any location based advertisements to be displayed can be displayed on an internal sign a predetermined number of stops prior to arriving at the location for the location-based advertisement.

At step 211, the current location and stop information is saved to the local database 16 on the remote device 21/22. At step 212, it is determined if the auto update is enabled. If it is determined at step 212 that the auto update is not enabled, then the customer onboard process 200 then skips the step 215. However, if it is determined at step 212 that the auto update is enabled, then it is determined at step 213 if Internet connectivity is available. If it is determined at step 213 that the Internet connectivity is not available, then the customer onboard process 200 then skips the step 215. However, if it is determined at step 213 that Internet connectivity is available, then all the collected data on remote device 21/22 is uploaded to server 11 database 12.

At step 215, it is determined if the vehicle is still active on the predetermined route. If it is determined that the vehicle is still actively proceeding on the predetermined route, then the customer onboard process 200 returns to repeat steps 202 - 215. However, if it is determined at step 215 that the vehicle not actively on the predetermined route, then the customer onboard process 200 instructs the driver to precede with the vehicle to the vehicle depot at step 216. At step 217, it is determined if all the data stored on remote device 21/22 has been uploaded to server 11. If it is determined at step 217—all the data on the remote device 21/22 has been uploaded to the server 11, then the customer onboard process 200 skips to step 219. However, if it is determined in step 217 that not all of the data on the remote device 21/22 has been uploaded to the server 11, then the remote device 21/22 then uploads all untransmitted data to server 11 at step 218.

At step 219, the customer onboard process 200 then exits.

FIG. 7B is a flow chart illustrating an example of the operation of the capture passenger data process 220 on the server 11 that is utilized in vehicle passenger management system 100 of the present invention, as shown in FIGS. 2A-3. A brief overview of one exemplary process is as follows: 1) it is determined if the passenger is to be validated; 2), if it is determined that the passenger is not to be validated, then the passenger is counted and then exits; 3) if it is determined that passenger validation is required, then it is determined if the passenger is to self validate; 4) if it is determined that the passenger is to self validate, then the passenger provides the passenger identifier is counted and then exits; 5) if it is determined that the passenger is not to self validate, then the passenger provides the identifying media to system; 6) it is then determined if database validation is to be used on the identifying media; 7) if it is determined that the database validation method is not to be used, then the driver of vehicle evaluates the identifying media provided by the customer and proceeds to determine if the passenger is valid; 8) if it is determined that database validation is to be used, then the identification number provided by the identifying media is compared to the database; 9) it is then determined if configuration validation is required for this passenger; 10) if configuration validation is required, then the capture passenger data process 220 compares the stop, time, route, vehicle, demographics or other authorization data against that in the passengers identifying media; 11) determine if the passenger is valid; 12) if the passenger is not valid, the customs operation policy determines the action against the passenger; 13) the passengers are counted in the validation information is captured; and 14) exit.

First at step 221, the capture passenger data process 220 is initialized. This initialization includes the startup routines and processes embedded in the BIOS of the server 11. The initialization also includes the establishment of data values for particular data structures utilized in the capture passenger data process 220.

At step 222, the capture passenger data process 220 determines if the passenger is to be validated. If it is determined that the passenger is not to be validated, then the capture passenger data process 220 skips to step 235. However, if it is determined that passenger validation is required, then the capture passenger data process 220 determines if the passenger is to self validate at step 223. If it is determined that the passenger is to self validate, then the passenger provides the passenger identifier, at step 224. The capture passenger data process 220 then skips to step 235. However, if it is determined that the passenger is not to self validate, then the passenger provides the identifying media to system at step 225. The identifying media includes, but is not limited to, RFID tag, magnetic stripe, biometric (i.e. thumbprint, face recognition, retinal scan and the like), keypad code, barcode (i.e. on a pass card, paper printout, displayed on a smart phone or tablet, and the like) or parking ticket credential (i.e. on a pass card, paper printout, displayed on a smart phone or tablet, and the like).

At step 226, it is then determined if database validation is to be used on the identifying media provided at step 225. If it is determined that the database validation method is not to be used, then the driver of vehicle evaluates the identifying media provided by the customer. In one embodiment, the driver the vehicle would just look at the picture ID of the passenger. The capture passenger data process 220 then skips to step 233. However, if it is determined at step 226 that database validation is to be used, then the identification information from the identifying media is validated. In one embodiment, the identifying media is compared to information in the database 16 on the remote device 21/22. In another embodiment, the validation is obtained by comparing the identifying media to data on database 12 on server 11. This assumes that the remote device 21/22 is electronically connected to server 11 across some network.

At step 231, it is determined if the configuration validation is required. If configuration validation is not required, then the capture passenger data process 220 then skips to step 233. However, if it is determined at step 231 that configuration validation is required, then the passenger identifying media is validated for the passenger to confirm that the passenger has authorization to access that particular vehicle stop, is authorized to be on the vehicle at that time, on that particular vehicle route, on that particular vehicle or the like.

At step 233, the capture passenger data process 220 then determines if the passenger is valid. If the passenger is valid, the capture passenger data process 220 skips to step 235. However, if the passenger is not valid, the customs operation policy determines the action against the passenger step 234.

At step 235, the passengers are counted and the validation information is captured. In one embodiment, the passenger count and validation information is saved to the database 16 on the remote device 21/22. In another embodiment, the passenger count and validation information is saved to database 12 on server 11. The capture passenger data process 220 then exits at step 239.

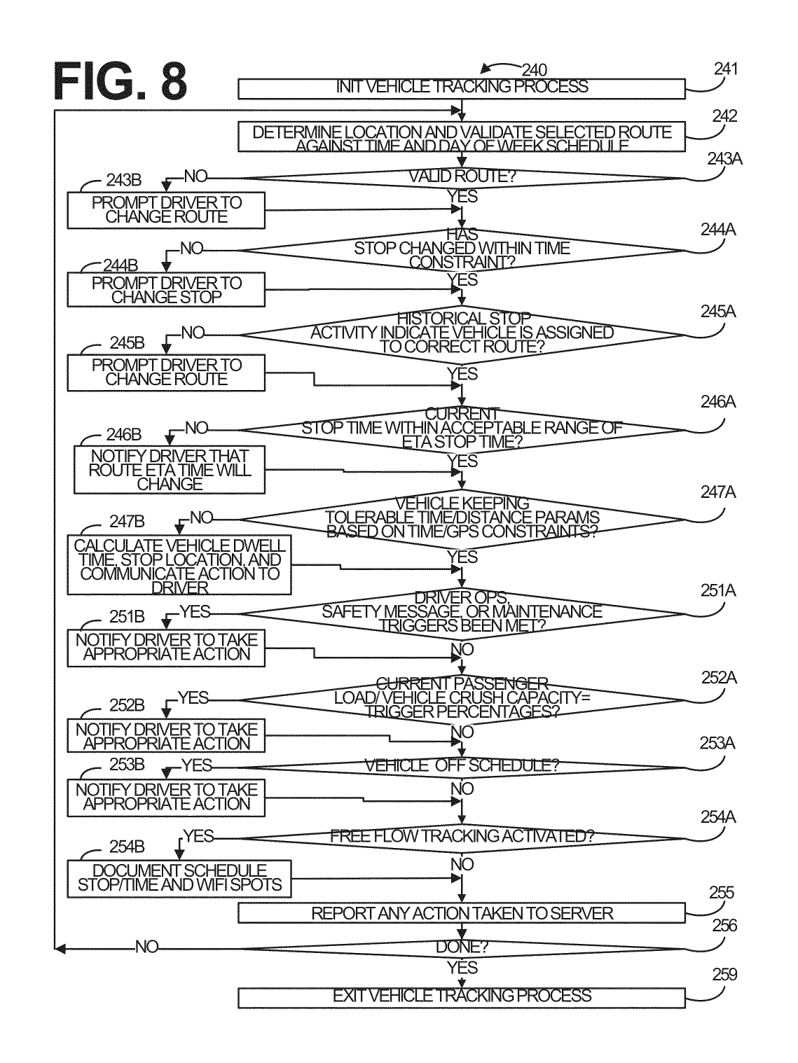

FIG. 8 is a flow chart illustrating an example of the operation of the vehicle tracking process 240 on the host that is utilized in vehicle passenger management system 100 of the present invention, as shown in FIGS. 2A-3. In one embodiment, a tracking action occurs to validate that the vehicle is on the predetermined route and is compared against time it and day of week schedule to see if it is on schedule. In an alternative embodiment, a tracking action verifies that the vehicle is keeping tolerable time/distant parameters based on time/GPS constraints. In still another alternative embodiment, a mobile remote device 21/22 are used for verifying that the driver of the vehicle is on the selected route and is on time. A brief overview of one exemplary process is as follows: 1) the vehicle's current location is determined and is validated against the currently selected route against time and day of week schedule; 2) determine if the vehicle is on the valid route and if not prompting the driver to change to the appointed route; 3) determine if the stops have changed within the appointed time constraints and prompt the driver to change stops if not; 4) determine if the historical stop activity indicates the vehicle is assigned to the correct route and change if not; 5) determine if the current stop time is within acceptable range of estimated time of arrival stop times and notifying the driver that the route estimated time of arrival will change if not; 6) determining if the vehicle is keeping tolerable time/distance parameters between vehicles based upon time/GPS constraints, and if not calculate vehicle dwell times stop location and communicate action to the driver; 7) determine if the driver operations, safety message or maintenance triggers have been met and if so notify the driver to take the appropriate action; 8) determine if the current passenger load/vehicle crush capacity is equal to the trigger percentages and notifying the driver to take the appropriate action if they have been met; 9) determine if there is more vehicle tracking to occur and repeating steps 1-9 if more tracking is needed; and 10) exit if more vehicle tracking is not needed.

First at step 241, the vehicle tracking process 240 is initialized. This initialization includes the startup routines and processes embedded in the BIOS of the server 11. The initialization also includes the establishment of data values for particular data structures utilized in the vehicle tracking process 240.

At step 242, the vehicle tracking process 240 determines the vehicle's current location and compares the current vehicle location against the currently selected route for the current time and day of week schedule. At step 243A, it is determined if the vehicle is on the valid route. If it is determined that the vehicle is on the correct route, then the vehicle tracking process 240 then skips to step 244A. However, if it is determined at step 243A that the vehicle is not on the correct route, then the vehicle tracking process 240 prompts the driver to change to the correct route, at step 243B. In one embodiment, the vehicle tracking process 240 gives directions to the driver to the correct route to coincide with the proper stop schedule.

At step 244A, it is determined if the stop is within the current time constraints. If it is determined at step 245 that the stop change is within the time constraints, then the vehicle tracking process 240 then skips to step 245A. However, if it is determined at step 244A that the stop changes is not within the time constraints, then the vehicle tracking process 240 prompts the driver to change the stop times at step 244B.

At step 245A, it is determined if the historical stop activity indicates that the vehicle is assigned to the correct route. If it is determined at step 245A that the historical stop activity of the vehicle indicates that the vehicle is on the assigned route, then the vehicle tracking process 240 then skips the step 246A. However, if it is determined at step 245A that the historical stop activity of the vehicle indicates that the vehicle is not on the assigned route, then the vehicle tracking process 240 prompts the driver to change the route at step 245B. In one embodiment, the vehicle tracking process 240 can give directions to the driver to proceed to the assigned route.

At step 246A, the vehicle tracking process 240 determines if the current stop time is within acceptable range of estimated time of arrival (ETA) stop times. If it is determined at step 246A that the current stop time is within the acceptable range, then the vehicle tracking process 240 then skips to step 247A. However, if it is determined at step 246A that the current stop time is not within the acceptable range of ETA stop times, then the vehicle tracking process notifies the driver that the route ETA time will change at step 246B.

At step 247A, it is determined if the vehicle is keeping tolerable time/distance parameters between vehicles based upon time/GPS constraints. If it is determined at step 247A that the vehicle is keeping tolerable time/distance parameters between other vehicles, then the vehicle tracking process 240 then skips to step 251A. However, if it is determined at step 247A that the vehicle is not keeping tolerable time/distance parameters from other vehicles then the vehicle tracking process 240 calculate the vehicle dwell time, stop location and communicate the proper action to the driver at step 247B. In one embodiment, the driver will be instructed to reduce the time spent at the vehicle stops in order to reduce the time/distance to a vehicle in front of the current vehicle. In another embodiment, the driver will be instructed to increase the time spent at the vehicle stops in order to increase the time/distance to a vehicle in front of the current vehicle.

At step 251A, it is the determined if the driver operations, safety message or maintenance triggers have been met. If it is determined that none of these triggers has been met, then the vehicle tracking process 240 then skips to step 252A. However, if any one or combinations of these triggers have been met, then the vehicle tracking process 240 notifies the driver to take the appropriate action for each of the triggers at step 251B. In one embodiment, these triggers are displayed on the remote device 21/22 for driver notification. In an alternative embodiment, the vehicle tracking process 240 can notify the driver by email, voicemail, flashing light, and the like.

At step 252A, it is determined if the current passenger load/vehicle crush capacity is equal to the trigger percentages. If it is determined at step 252A that the current passenger load/vehicle crush capacity is not equal to the trigger percentages, then the vehicle tracking process 240 then skips to step 253A. However, if it is just determined at step 252A that the current passenger load/vehicle crush capacity is equal to the trigger percentages, then the driver is notified to take the appropriate action at step 252B. In one embodiment, the notification is to restrict the number of passengers boarding the vehicle to be equal to the number of people disembarking. And another embodiment, the notification is to restrict any new passengers from entering the vehicle until the vehicle tracking process 240 determines that the passenger load/vehicle crush capacity trigger is no longer met.

At step 253A, it is determined if the vehicle is severely off its route schedule. If it is determined at step 253A that the vehicle is severely off its route schedule, the main driver is notified to take the appropriate action at step 253B. In one embodiment, the driver is instructed to find an appropriate space to wait until the next scheduled stop is to occur thereby putting the vehicle back on its route schedule.

At step 254A, it is determined if the free flow tracking is activated. Free flow tracking is enabled in order to create a reasonable route schedule taking into account traffic congestion and the time of day. If it is determined that free flow tracking is not enabled, then the vehicle tracking process 240 then skips to step 255. However, if it is determined at step 254 that free flow tracking is enabled, then the vehicle tracking process 240 proceeds to document the route schedule stops and time of the stops in order to create a reasonable route schedule taking into account the traffic patterns and time of day. In addition to documenting the route scheduled stops, the vehicle tracking process 240 also documents any Wi-Fi hot spots encountered on the route. This is to enable the vehicle tracking process 240 determine when Internet connectivity is available for uploading data to server 11.

At step 255, the vehicle tracking process 240 reports any actions taken to server 11 at the next available hotspot.

At step 256 it is determined if the vehicle tracking process 240 is to continue tracking the current vehicle. If it is determined at step 256 that the vehicle tracking process 240 is to continue tracking the current vehicle, then the vehicle tracking process 240 returns to repeat steps 242 through 255. However, if it is determined at step 256 that the vehicle tracking process 240 is not to continue tracking the current vehicle, then the vehicle tracking process 240 then exits at step 259.

FIG. 9 is a flow chart illustrating an example of the operation of the data display process 260 on the server 11 that is utilized in vehicle passenger management system 100 of the present invention, as shown in FIGS. 2A-3. In one embodiment, a data display action enables the driver to display certain trainings on the vehicle when in operation. A brief overview of one exemplary process is as follows: 1) determine if the user administration configuration is on and if so enable the driver set the vehicle configuration; 2), determine if the vehicle is to display the route and driver name and if so enable the display of the vehicle route and driver name; 3) determine if the next stop reference is to be displayed, and if so, determine the current location and the next stop and display the next stop; 4) save stop data in the database for the remote device; 5) determine if there is more data display to occur and repeating steps 1-5 if so; and 6) exit if more data display is not needed.

First at step 261, the data display process 260 is initialized. This initialization includes the startup routines and processes embedded in the BIOS of the server 11. The initialization also includes the establishment of data values for particular data structures utilized in the data display process 260.

At step 262, the data display process 260 it is determined if the driver administration configuration is set on. If it is determined at step 262 that the driver administration configuration is not on, then the data display process 260 skips the step 264. However, if it is determined at step 262 that the driver administration configuration is on, then the driver administration configuration is enabled at step 263. In one embodiment, this allows the driver to set the vehicle configuration. The vehicle configuration includes, but is not limited to the routes the vehicle is assigned to, the driver assigned to the vehicle the current day of the week, the current time and the like.

At step 264, it is determined if the vehicle is to display the route and driver name. If it is determined at step 264 that the display of the route and driver name is not to be performed, then the data display process 260 skips to step 266. However, if it is determined at step 264 that the display of the route and driver name is to occur, then the data display process 260 displays the route and driver name it steps 265. In one embodiment, the display is on the exterior displays only. In another embodiment, the display is on both the exterior and interior displays. In still another embodiment, the disk data displays are only enabled for those displays within the vehicle.

At step 266, it is determined if the next stop reference is to be displayed. If it is determined at step 266 that the next stop is not to be displayed, then the data display process 260 then skips to step 273. However, if it is determined at step 266 that the next stop is to be displayed, then the data display process 260 determines the current vehicle location and the next stop on the current route at step 271. At step 272, display the next stop is displayed. In one embodiment, the display is on the interior displays only. In another embodiment, the display is on both the exterior and interior displays.

At step 273, it is determined if the GPS data is to be displayed for all vehicles on that route. In one embodiment, the data GPS data is displayed only to the driver to provide a visual reference of his vehicles spatial distance two other vehicles on the route. In another embodiment, this data is provided to servers 11 so that the administration may visualize all vehicles spatial distance on a particular route. In still another embodiment, the GPS data is provided to both the driver and the administration. If it is determined that step 273 that GPS data is not to be displayed for the vehicles on the route, then the data display process 260 skips to step 275. However, if it is determined at step 273 that GPS data is to be displayed for all vehicles on that route

At step 275, the stop data is stored in the database for the remote device 21/22. At step 274, it is determined if the data display process 260 is to display more display data. If it is determined at step 27 that the data display process 260 is to display additional data, then the data display process 260 returns to repeat steps 262-274. However, if it is determined at step 274 that there are no more data to be displayed, then the data display process 260 then exits at step 279.

FIG. 10 is a flow chart illustrating an example of the operation of the status reports process 280 on the server 11 that is utilized in vehicle passenger management system 100 of the present invention, as shown in FIGS. 2A-3. In one embodiment, a status reports action enables management to receive reports with regard to a vehicle's location, all vehicles location, a list of current customers, trend analysis, and the like. A brief overview of one exemplary process is as follows: 1) perform data calculations and data consolidations in database 12; 2) determine if a vehicle location request is received and provide the report of the specific vehicle location; 3) determine if all vehicles location report is requested and provide the report including each vehicle's location, the vehicles on active routes, current driver of each vehicle, deviation from the scheduled stop estimated time of arrival (ETA), vehicle maintenance status time to next service (including fuel fill ups) or the like; 4) determine if a customer report is requested and then provide the customer report by customer name; customer ID; customers currently on vehicles; number of vehicles trips for the current day, for the current week, for the current month; the or the like; 5) determine if a trend analysis report is requested and input trend analysis parameters (i.e. number of the vehicle, make/model/year of the vehicle, route that the vehicle, passenger count on the vehicle and the like); and 6) determine if more status reports are to be executed and if so returned repeat steps 1-6, or else exit.

First at step 281, the status reports process 280 is initialized. This initialization includes the startup routines and processes embedded in the BIOS of the server 11. The initialization also includes the establishment of data values for particular data structures utilized in the status reports process 280.

At step 282, the status reports process 280 perform data calculations and data consolidations in database 12. In one embodiment, this invokes a call to all vehicles to download any previously un-downloaded data. Once all the un-downloaded data has been received, the status reports process 280 then consolidates the data in database 12.

At step 283, it is determined if the request received is a vehicle location request. If it is determined at step 283 that the request received was not a vehicle location request, then the status reports process 280 then skips to step 286. However, if it is determined at step 283 that a vehicle location request has been received, then the status reports process 280 then request the user to input the vehicle parameters to a identify the vehicle whose location is requested. The vehicle parameters that can be used to identify a specific vehicle include, but are not limited to the VIN, make model year, vehicle number and the like. Once the vehicle parameter identifying the particular vehicle to be located is received, then the status reports process 280 looks up the vehicle location by the input parameters and displays that information to the user at step 285. In one embodiment, the display of the data to user is on display 46 (FIG. 2A). And another embodiment, the display of the data to the user is on a printer (not shown) attached to server 11 using local interface 43.

At step 286, it is determined if the request received was an all vehicles location report. An all vehicles location report is a request to determine the location of each and every vehicle for the transportation entity identified. In one embodiment, this location information is accessed from the GPS tracking unit on each vehicle. In another embodiment, this information is gathered from the last known location of each vehicle. If it is determined in step 286 that the request was not an all vehicles location requests, then the status reports process 280 then skips to step 291. However, if it is determined at step 286 that the request received was for the location of all vehicles, then the status reports process 280 provides the report of all vehicles location. In one embodiment, the display of the data to user is on display 46 (FIG. 2A). And another embodiment, the display of the data to the user is on a printer(not shown) attached to server 11 using local interface 43. The all vehicles location report includes, but is not limited to, each vehicle's location, the vehicles on active routes, current driver of each vehicle, deviation from the scheduled stop ETA's, vehicle maintenance status time to next service (including fuel fill ups) or the like.

At step 291, it is determined if a customers report is requested. If it is determined at step 291 that the customers report was not requested, then the status reports process 280 then skips to step 293. However, if it is determined at step 291 that a customers report list was requested, then the status reports process 280 provides the customers report requested at step 291. The customers report includes, but is not limited to, customer name; customer ID; customers currently on vehicles; number of vehicles trips for the current day, for the current week, for the current month; the or the like.

At step 293, it is determined if a trend analysis report is requested. If it is determined at step 293 that a trend analysis report was not requested, then the status reports process 280 then skips to step 296. However, if it is determined at step 293 that a trend analysis report was requested, then the status reports process 280 requests input of the trend analysis parameters (i.e. number of the vehicle, make/model/year of the vehicle, route that the vehicle, passenger count on the vehicle and the like), at step 294. At step 295, the status reports process 280 provides a list of the specific data requested in the trend analysis report.

At step 296, it is determined if the status reports process 280 is to process additional report requests. If it is determined at step 296 that the status reports process 280 is to process additional report requests, then the status reports process 280 returns to repeat steps 282 through 296. However, if it is determined at step 296 that there are no more report requests to be received, then the status reports process 280 then exits at step 299.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

While the invention has been described with reference to preferred and example embodiments, it will be understood by those skilled in the art that a variety of modifications, additions and deletions are within the scope of the invention, as defined by the following claims.

What is claimed is:

1. A method for providing management of a transportation system embodied in a computer program product for execution on an instruction processing system, comprising a tangible storage medium readable by the instruction processing system is storing instructions for execution by the instruction processing system for performing the method comprising:
loading passenger credential data into a database on a remote device;
collecting a passenger identifying media to verify the passenger has a ticket;
comparing the passenger identifying media to the passenger credential data in the database on the remote device;
allowing the passenger to board the vehicle if the passenger has a valid ticket; and
following a customer operations policy action if the passenger does not have a valid ticket.

2. The method of claim 1, further comprising:
verifying that the ticket for the passenger identifying media is not currently in use;
notifying an attendant that the ticket for the passenger identifying media is currently in use; and
requiring the customer to purchase the new ticket if the ticket for the passenger identifying media is already in use.

3. The method of claim 1, further comprising:
increasing a vehicle passenger count for each of the passengers that board the vehicle; and
decreasing the vehicle passenger count for each of the passengers that de-boards the vehicle.

4. The method of claim 3, further comprising:
capturing stop data each time the passenger boards and de-boards the vehicle, wherein the stop data is selected from the group consisting of vehicle passenger count , GPS location, time, date, driver name, route name, and stop name associated with the vehicle passenger count; and
uploading the stop data to a server when wireless connectivity is detected.

5. The method of claim 4, further comprising:
determining if vehicle passenger count exceeds a passenger trigger percentage;
providing alerts for exceeding the passenger trigger percentages; and
uploading the vehicle passenger count and passenger trigger percentage to a server when wireless connectivity is detected.

6. The method of claim 1, wherein allowing the passenger to board the vehicle further comprises:
validating passenger credentials against a passenger access rules wherein the passenger access rules is selected from the group consisting of stop location, allowable time for access, specific route access, specific day, period of day access, and route.

7. The method of claim 1, wherein allowing the passenger to board the vehicle further comprises:
providing alerts for identifying specific boarding passengers; and
uploading the alerts to a server when wireless connectivity is detected.

8. The method of claim 1, further comprising:
determining a GPS location of all vehicles on the route;
calculating space between each of the multiple vehicles on the same route for optimal service;
providing instructions to each driver of each of the multiple vehicles on the same route of an action to obtain optimal service.

9. The method of claim 8, wherein providing instructions to each driver of each of the multiple vehicles is selected from the group consisting of text based informational instructions and graphical/map representation showing other vehicle locations in relation to the current vehicle.

10. The method of claim 1, further comprising:
calculating an appropriate stop time for a particular route, trip, and run to compute a route schedule.

11. The method of claim 1, wherein the passenger identifying media is selected from the group consisting of RFID tag, Mag Stripe pass , BioMetric pass , Keypad Code, and parking ticket credential.

12. A system that providing management of a transportation system on a mobile device, comprising:
an instruction processing system;
a tangible storage medium readable by the instruction processing system and storing instructions for execution by the instruction processing;
a creation module
a passenger credential data load module stored in the tangible storage medium that when executed by the instruction processing system that loads passenger credential data into a database on the remote device;
a passenger identifying media collection module stored in the tangible storage medium that when executed by the instruction processing system verifies the passenger has a ticket by comparing passenger identifying media to the passenger credential data in the database on the remote device, wherein the passenger identifying media collection module indicates allowing the passenger to board the vehicle if the passenger has a valid ticket; and wherein the passenger identifying media collection module indicates following a customer operations policy action if the passenger does not have a valid ticket.

13. The system of claim 12, wherein the passenger identifying media collection module further comprises:
a ticket module stored in the tangible storage medium that when executed by the instruction processing system verifies that the ticket for the passenger identifying media is not currently in use, notifies an attendant that the ticket for the passenger identifying media is currently in use, and requires the customer to purchase the new ticket if the ticket for the passenger identifying media is already in use.

14. The system of claim 12, further comprising:
a vehicle passenger count module in the tangible storage medium that when executed by the instruction processing system increases a vehicle passenger count for each of the passengers that board the vehicle and decreasing the vehicle passenger count for each of the passengers that de-boards the vehicle.

15. The system of claim 12, wherein the vehicle passenger count module further comprises:
capturing stop data each time the passenger boards and de-boards the vehicle, wherein the stop data is selected from the group consisting of vehicle passenger count , GPS location, time, date, driver name, route name, and stop name associated with the vehicle passenger count; and
uploading the stop data to a server when wireless connectivity is detected.

16. The system of claim 12, wherein the vehicle passenger count module further comprises:
determining if vehicle passenger count exceeds a passenger trigger percentage;
providing alerts for exceeding the passenger trigger percentages; and
uploading the vehicle passenger count and passenger trigger percentage to a server when wireless connectivity is detected.

17. The system of claim 12, wherein the passenger identifying media collection module further comprises:
validating passenger credentials against a passenger access rules wherein the passenger access rules is selected from the group consisting of stop location, allowable time for access, specific route access, specific day, period of day access, and route.

18. The system of claim 12, wherein the passenger identifying media collection module further comprises:
providing alerts for identifying specific boarding passengers; and
uploading the alerts to a server when wireless connectivity is detected.

19. The system of claim 12, further comprising:
a GPS determination module stored in the tangible storage medium that when executed by the instruction processing system determines a GPS location of all vehicles on the route; and
a space calculation module stored in the tangible storage medium that when executed by the instruction processing system calculates space between each of the multiple vehicles on the same route for optimal service, and provides instructions to each driver of each of the multiple vehicles on the same route of an action to obtain optimal service.

20. The system of claim 19, wherein the space calculation module further comprises:
providing instructions to each driver of each of the multiple vehicles is selected from the group consisting of text based informational instructions and graphical/map representation showing other vehicle locations in relation to the current vehicle.

21. The system of claim 12, further comprising:
a route scheduling module stored in the tangible storage medium that when executed by the instruction processing system calculates an appropriate stop time for a particular route, trip, and run to compute a route schedule.

22. The system of claim 12, wherein the passenger identifying media is selected from the group consisting of RFID tag, Mag Stripe pass , BioMetric pass , Keypad Code, and parking ticket credential.
